(19) United States
(12) Patent Application Publication
(10) Pub. No.: US 2006/0091343 A1
(43) Pub. Date: May 4, 2006

(54) Valve assembly with side inlet

(76) Inventor: Ali Marandi, Irvine, CA (US)

Correspondence Address: Boniard I. Brown, #113, 1500 West Covina Parkway, West Covina, CA, 91790-2793, US

(21) Appl. No.: 10/979,523

(22) Filed: Nov. 1, 2004

(51) Int. Cl. F16K 51/00; F16L 37/28

(52) U.S. Cl. 251/149.4

(57) ABSTRACT

A side inlet is provided on a valve assembly about which inlet the assembly is rotatable and the valve assembly is rotatable to prevent damage thereto upon impact or force imposed on the valve assembly.

### BACKGROUND AND SUMMARY OF THE INVENTION

Quick coupling valve assemblies have long been known in the prior art and have generally embodied coaxial bottom inlets for water or other liquid.

An elongate member has generally been secured to a valve base and enables valve assembly rotation about a vertical axis.

Such prior art valve assemblies are subject to damage, leakage and unwanted discharge of water upon impact as by a vehicle, golf cart, vandalism, etc. Such damages result from the impact upon the valve assembly damaging the water input means at the bottom of the assembly.

The present invention provides a valve assembly having a side inlet instead of the prior art vertically oriented inlet. The valve assembly is rotatably threadedly mounted on the side inlet so that upon impact or a blow on the apparatus it rotates about the side inlet instead of being damaged or broken, and the valve assembly remains functional.

The present invention provides a side inlet on a valve assembly for liquid intake about which inlet the assembly is rotatable. The valve assembly is rotatable to prevent damage thereto upon impact or force being imposed on the valve assembly.

### BRIEF DESCRIPTION OF THE DRAWINGS

FIG. 1 is an elevational view of a valve assembly according to the invention disposed on a conventional swing joint riser for positioning the valve in three-dimensional space;

FIG. 2 is a partial sectional view of an embodiment of the invention wherein a valve side inlet of the invention is threadedly connected with an inlet conduit;

FIG. 3 is a partial sectional view of a side inlet according to the invention connected with a threaded nipple on a conduit;

FIG. 4 is a partial sectional view of an inlet portion of the valve assembly wherein the inlet has square threads to receive a conduit with similar threads;

FIG. 5 is a partial sectional view of an embodiment of the invention wherein a conduit member has an annular flange engaging the valve assembly side inlet, with components secured together by a clamp member;

FIG. 6 is a sectional view of a valve assembly according to the invention in closed configuration; and

FIG. 7 is an elevational sectional view of a preferred embodiment of FIG. 6 wherein the side inlet is threadedly connected with an inlet conduit member.

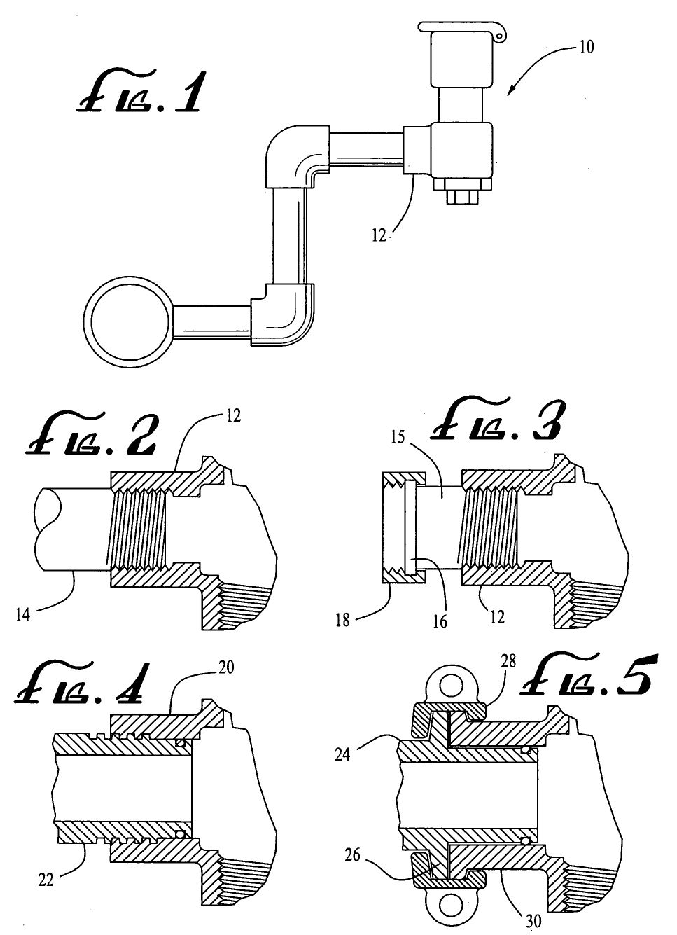

### DESCRIPTION OF PREFERRED EMBODIMENTS

Referring to the drawings, a preferred embodiment 10 of the present invention is shown in FIGS. 6 and 7.

The present invention embodies a side inlet 12 instead of a conventional vertically oriented inlet.

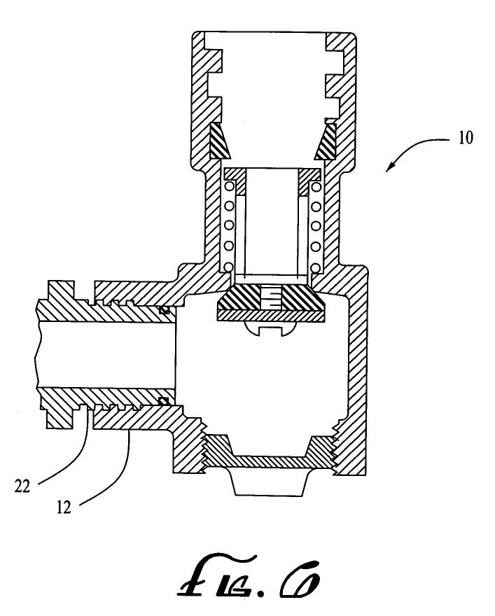

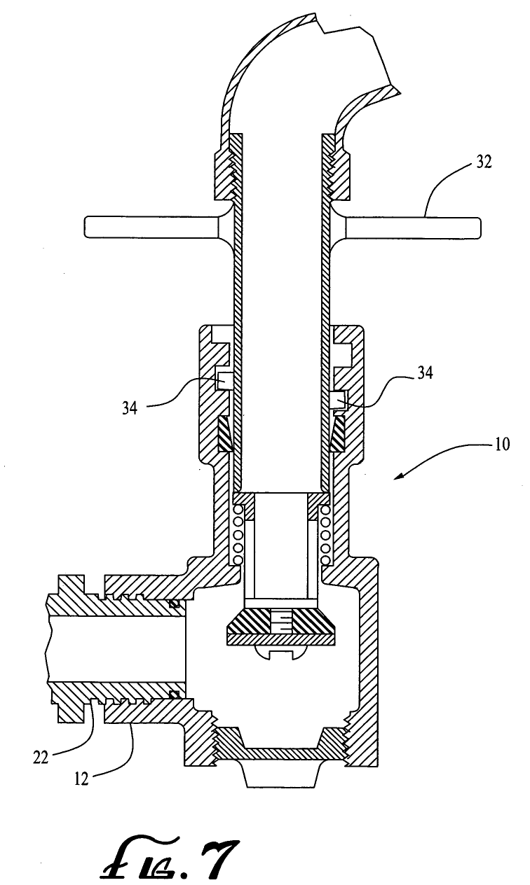

Illustrated in FIGS. 2 through 5 are respective embodiments of interconnections between a valve side inlet 12 and respective liquid input components. FIG. 2 illustrates a side inlet 12 threadedly connected with an input conduit member 14. FIG. 3 shows a side inlet 12 and a threaded end portion of a conduit nipple 15, a flanged end portion 16 of which is disposed in an annular groove in a threaded end portion of a water conduit 18. FIG. 4 shows a valve side inlet 20 having square threads to receive a similarly threaded conduit end portion 22, with a resilient annular seal between the side inlet and the conduit end portion. FIG. 5 shows an embodiment wherein a conduit member 24 has an annular flange 26 which engages and end portion of a valve side inlet 30, these components being retained together by a retaining clamp member 28, as shown.

In the operation and use of the valve assembly according to the invention, the assembly is actuated in conventional manner to effect the dispensing or spray of water by pushing downwardly on and rotating the valve key handle 32, referring to FIG. 7, to engage a key lug member 34. The key handle is turned 90° to 180° to engage the key lug member. Like valve assemblies of the prior art, the valve assembly of the invention cannot become unscrewed in the manner of valve assemblies of the prior art, Such unscrewing about the longitudinal axis typically occurs after a long period of service and wear or through vandalism. The probability of conventional valve assemblies becoming loosened and disengaged substantially increases after a long period of service or through vandalism. Such loosening and disengagement result in failure, with leakage, water gushers, and possible injury to persons and damage to property.

A valve assembly of the invention, upon impact thereon, rotates about the side inlet 12 on which it is threadedly mounted, typically through a substantial angle up to 90°, and the valve assembly is thus not seriously damaged by a blow from an impact or by vandalism.

The swivel inlet according to the invention, provides safe operation with no added cost of separate stabilizers which otherwise would be required.

It will be understood that various changes and modifications may be made from the preferred embodiments discussed above without departing from the scope of the present invention, which is established by the following claims and equivalents thereof.

1. A valve assembly comprising:
liquid output means for dispensing liquid from the valve assembly,
a side inlet for liquid intake to the valve assembly, the valve assembly being rotatably mounted on the conduit for relative rotation, and
an inlet conduit member on which said side inlet and valve assembly are rotatably mounted for rotation upon impact or force exerted on the valve assembly, whereby damage to the valve and leakage therefrom are prevented.

2. A valve assembly according to claim 1 wherein said liquid dispensed is water.

3. A valve assembly according to claim 1 wherein said liquid output means comprises means for spraying water.

4. A valve assembly according to claim 1 and further comprising sealing means between said side inlet and said inlet conduit member.

5. A valve assembly according to claim 1 and further comprising sealing means between the conduit member and the valve inlet.

6. A valve assembly according to claim 5 wherein said sealing means comprises an annular resilient seal in a groove in said conduit member by engaging the valve inlet.

7. A valve assembly according to claim 1 wherein said inlet conduit member has an annular flange portion retained by a shoulder on the side inlet.

8. A valve assembly comprising:
liquid output means for dispensing liquid from the valve assembly,
a side inlet for liquid input to the valve, said side inlet being connected with a source of liquid,
the valve assembly being rotatably mounted on the conduit member for relative rotation therebetween,
whereby upon impact or force being imposed on the valve assembly damage to the valve and leakage therefrom are prevented,
a conduit member having a substantially annular flange engaging a portion of said side inlet, and
clamping means comprising said conduit member annular flange and a flange on the outer end of said valve side inlet to retain the conduit member relative to the side inlet of the valve assembly.

9. A valve assembly according to claim 8 wherein said liquid dispensed is water.

10. A valve assembly according to claim 8 wherein said liquid output means comprises means for spraying water.

11. A valve assembly according to claim 8 and further comprising sealing means between said side inlet and said inlet conduit member.

12. A valve assembly according to claim 8 and further comprising sealing means between said conduit member and said valve inlet.

13. A valve assembly according to claim 8 wherein said sealing means comprises an annular resilient seal in a groove in said conduit member and engaging said valve inlet.

14. A valve assembly according to claim 8 wherein said inlet conduit member has an annular flange portion retained by a shoulder on the side inlet for relative rotation.

15. A valve assembly according to claim 8 wherein said conduit member and said side inlet are threadedly engaged for limited relative rotation.
